(19) United States
(12) Patent Application Publication
(10) Pub. No.: US 2026/0159612 A1
(43) Pub. Date: Jun. 11, 2026

(54) Bimodal or multimodal cellulose materials and methods for producing such

(71) Applicant: Teknologian tutkimuskeskus VTT Oy, Espoo (FI)

(72) Inventors: Pauliina Ahokas, Espoo (FI); Ali Harlin, Espoo (FI); Hannes Orelma, Espoo (FI); Ilona Leppänen, Espoo (FI)

(21) Appl. No.: 18/707,184

(22) PCT Filed: Nov. 4, 2022
(86) PCT No.: PCT/FI2022/050724

§ 371 Date: May 3, 2024

(30) Foreign Application Priority Data
Nov. 5, 2021 (FI) 20216144

(51) Int. Cl. C08B 16/00

(52) U.S. Cl. CPC C08B 16/00

(57) ABSTRACT

According to an example aspect of the present invention, there is provided a method for producing bimodal and/or multimodal cellulose materials, such as films and filaments, which combine the benefits of cellulosic raw materials having different average size (degree of polymerization) and/or molecular weight distribution.

### FIELD

The present invention relates to improved processability and mechanical performance of regenerated cellulose materials, and to methods for producing bimodal or multimodal regenerated cellulose films and filaments having such properties. Bimodality or multimodality in this case relates to combining cellulosic pulps with differing average molecular weights (or molar masses) via cellulose dissolution.

### BACKGROUND

Currently, regenerated cellulose films are made of unimodal cellulose material with only one molecular weight distribution maximum. Plastic industry uses bimodal and multimodal structures for example in bimodal high density polyethylene (HDPE), linear low density polyethylene (LLDPE) and even lately polypropylene (PP) resins as they benefit from their bimodality by having the strength and stiffness of HDPE, whilst retaining the high-stress-crack resistance and processability of a unimodal medium density polyethylene. For example, Yandi et al. (2009) characterizes the microstructure of bimodal HDPE-resin.

Performance of standalone cellulose films has been limited because processing of high molar mass pulp has not been possible due to extensive viscosities, which is one of the root causes why regenerated cellulose films have not yet been competitive with synthetic materials in similar applications.

Some recent and partly relevant publications relating to cellulose films aiming for replacing synthetic raw materials exist. For example, WO 2018/228744 A1 discloses a composition comprising a combination of cellulosic polymers, which can be used for manufacturing films or foils. The disclosed cellulose based composition could replace films or foils based on fossil raw materials, and which are used as packing or wrapping materials. However, the cellulosic polymers mentioned in the patent application are selected from the group consisting of cellulose acetate butyrate, cellulose acetate propionate and ethyl cellulose, not for example molecular mass controlled cellulose or any cellulosic material naturally occurring regardless if containing minor components like hemicellulose or lignin for regenerated process.

WO 2019/073370 A1 relates to a process for improving the stretchability of films comprising high amounts of microfibrillated cellulose (MFC) without negatively impacting the oxygen barrier properties. According to the disclosure, a film is formed from a suspension comprising microfibrillated cellulose having a broad size distribution. However, the described method does not apply dissolution of celluloses.

US 2018/0371211 A1 on the other hand discloses a method for producing cellulosic material that has bimodal fibril distribution. The composition can be used to modify rheological properties of components. This US-publication does not, however, relate to methods of preparing cellulose films via for example dissolution and regeneration. Further fibril distribution reflects to particle size and form while here intended molecular weight distribution stands for molecule sizes and optionally type only.

US 2019/0316293 A1 aims for improving high aspect ratio cellulose filament blends and involves providing a blend of cellulose nano-filaments or blend of cellulose micro-filaments, diluting the blend of cellulose nano-filaments or blend of cellulose micro-filaments to a target consistency, fractionating diluted blend of cellulose nano-filaments or diluted blend of cellulose micro-filaments into, at least, a high-solids fraction and a low-solids fraction, and collecting the fraction of diluted blend of cellulose nano-filaments or diluted blend of cellulose micro-filaments. The described method can be used for example for improving high aspect ratio cellulose filament blends used in plastic composite products, coating films, and concrete products. The film forming capacity is based on assemble of individual cellulose fibres and tight fibre-fibre interactions formed upon drying. This US-publication does not apply dissolution of cellulose that disrupts intra- and intermolecular interactions between individual cellulose polymer chains, enabling celluloses conformation changes and so on film forming ability during regeneration.

It is known in the art that processability of high molecular weight cellulose solutions is poor, but they usually provide good mechanical properties for regenerated cellulose films. Solutions with low molecular weight cellulose are easy to operate due to low solution viscosity, but in turn the prepared cellulose films have poor mechanical properties. Likewise, high molar mass molecules are processable to certain limit in dilute solution, but this procedure is limited and leads to handling high volumes of solvents and thereafter challenges in process and its economy. There is thus a need for a novel technology for achieving regenerated cellulose films, fibers and such, which combine both good processability of dissolved cellulose solutions and good mechanical performance of regenerated cellulose products.

### SUMMARY OF THE INVENTION

The invention is defined by the features of the independent claims. Some specific embodiments are defined in the dependent claims.

According to an aspect of the present invention, there is provided a method for producing bimodal or multimodal regenerated cellulose films and/or filaments and thereby combining the benefits of different cellulosic raw materials at least in terms of processability and mechanical performance.

This and other aspects, together with the advantages thereof over known solutions are achieved by the present invention, as hereinafter described and claimed.

The method of the present invention is mainly characterized by what is stated in the characterizing part of claim 1.

The bimodal or multimodal film thereof is mainly characterized by what is stated in the characterizing part of claim 7.

Considerable advantages are obtained by means of the present invention. For example, the processability and mechanical properties of regenerated cellulose materials can be improved and genuinely controlled in a desired manner depending on the requirements of the end-products. Better mechanical properties are beneficial for processing and end-use application point of view. The concept enables reaching attractive rheological properties for processing by adding low molecular weight cellulose, maintaining high tensile modulus by adding high molecular weight cellulose and reaching such properties even with high elongations and shorter side chain materials. Furthermore, improved mechanical properties increase the usability of cellulose derivatives (modified long chain fatty acid) and enable the commercialization of the present concept.

Next, the present technology will be described more closely with reference to certain embodiments.

### EMBODIMENTS

The present technology provides improved and controlled processability and mechanical properties of bimodal or multimodal regenerated cellulose materials by combining low molecular weight cellulose with high molecular weight cellulose (i.e. cellulose materials having different average degree of polymerization).

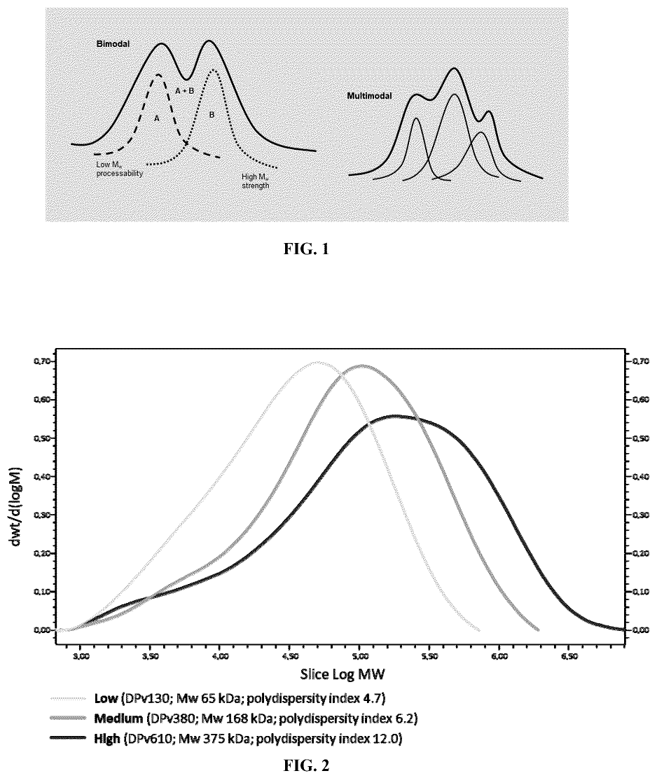

FIG. 1 is a schematic drawing describing the basic idea of bimodal and multimodal molecular weight distribution cellulose materials.

FIG. 2 is a chart showing molecular weight distributions, degree of polymerizations (DP), average molecular weights (Mw) and polydispersity indexes of used pulps with regard to regenerated cellulose films.

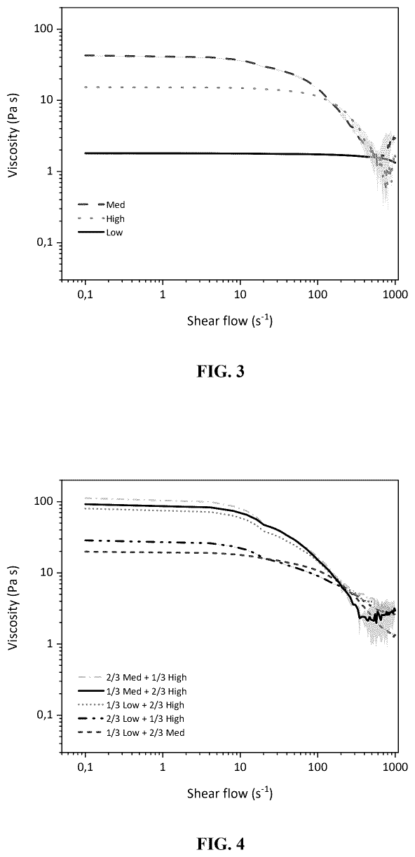

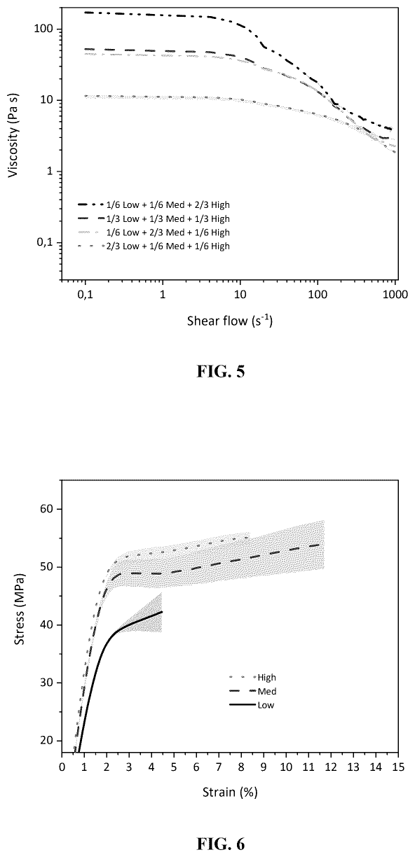

FIGS. 3, 4 and 5 are charts showing experiment results relating to solution viscosities (shear flows measured at 80° C.) with regard to regenerated cellulose films.

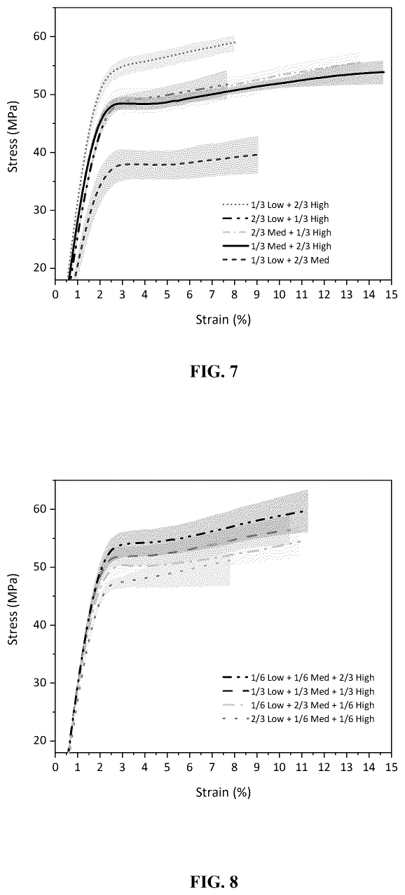

FIGS. 6, 7 and 8 are charts showing experiment results relating to tensile property measurements of regenerated cellulose films.

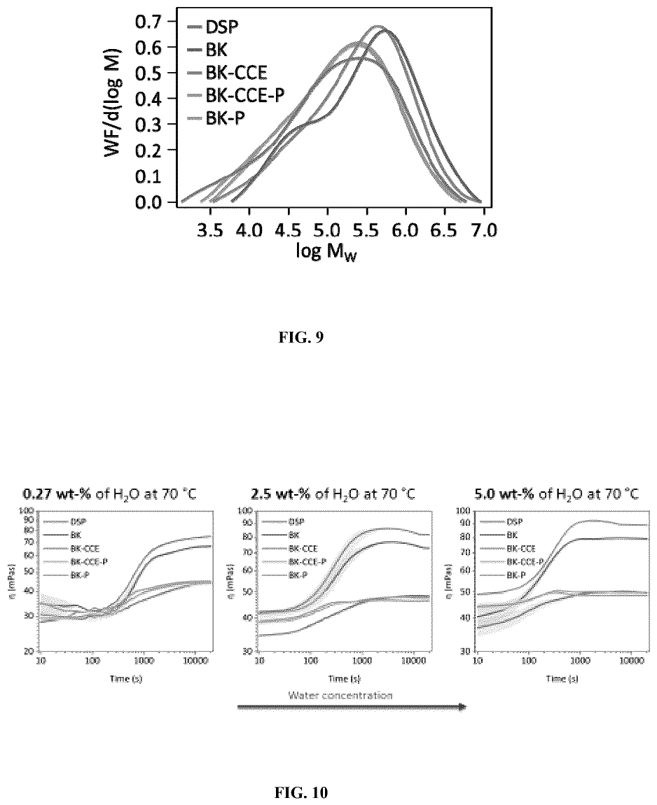

FIGS. 9, 10, 11 and 12 are charts showing the positive effect of hemicellulose to both solution rheology (lowers viscosity) and mechanical properties of regenerated cellulose films (higher tensile strength and elongation).

Low molecular weight (Mw) cellulose is in the present context of regenerated cellulose materials intended to mean anything below 200 kDa, such as for example below 100 kDa.

High molecular weight (Mw) cellulose is in the present context of regenerated cellulose materials intended to mean anything above 350-550 kDa, such as for example above 300 kDa.

Degree of substitution (DS) is the average number of substituent groups attached per base or monomeric unit.

According to one embodiment of the present invention, cellulose raw materials with two different degree of polymerization are dissolved, thereby forming a bimodal solution. Typically, bimodal systems are applied for example in polyolefins, but the phenomenon has not been applied for other polymers (such as for example cellulose). The phenomenon seems to be a universal behavior and the inventors of the present invention have shown this with a 4-methylmorpholine n-oxide solution/H₂O/cellulose-system. With bimodal systems, processability of the solution is maintained and strength and stiffness of regenerated films are improved.

Novel efficient solvents are essential in order to dissolve the cellulose materials efficiently and to utilize high molar mass cellulose materials. This is not shown nor has been expected earlier, and is one essential reason for making the idea of bimodal and multimodal thermoplastic and regenerated cellulose materials feasible.

Thus, according to an embodiment of the present invention, the method for producing regenerated cellulose films applies bimodal cellulose fibril distribution for providing good mechanical properties while having a lowered viscosity during processing.

According to one embodiment of the present invention, the method for producing bimodal or multimodal cellulose films and/or filaments comprises at least the steps of:
mixing together cellulose raw materials having at least two different average degree of polymerization, or at least two different average molecular weights or molecular weight distributions,
dissolving the mixed cellulose raw materials in a solvent and thereby forming a solution, and
regenerating the solution into a film or optionally filaments.

Regenerating the solution into a film or filaments is carried out by any conventional regeneration manufacturing method.

According to one embodiment of the present invention, the average molecular weight of the cellulose raw material is between 50 and 900 kDa, preferably between 50 and 400 kDa.

According to one embodiment of the present invention, the molecular weight ratio of the different cellulose raw materials is below 6, preferably above 2.5.

According to one embodiment of the present invention, the solution viscosity ratio of the different dissolved cellulose solutions is below 20, preferably above 5, at 10 s⁻¹ shearing.

According to one embodiment of the present invention, the used solvent is selected from non-derivatizing cellulose solvents, amine oxide cellulose solvents and alkaline cellulose solvents, such as for example 4-methylmorpholine n-oxide.

One aspect of the invention is that it involves a dissolution step in which intra- and intermolecular interactions between cellulose chains are disrupted enabling celluloses conformation changes and so on film forming ability during regeneration.

A bimodal or multimodal cellulose film having tensile strength of at least 30 MPa and elongation of at least 5% belongs also to the scope of the present invention.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated.

### INDUSTRIAL APPLICABILITY

Plastic industry applies bimodal systems (HDPE, LLDPE, PP) as they benefit from their bimodality by having the strength and stiffness of HDPE, whilst retaining the high-stress-crack resistance and processability of a unimodal medium density polyethylene. Currently, regenerated cellulose is made of unimodal cellulose material. It is therefore advantageous and industrially attractive to apply bimodal and multimodal systems also into cellulosic materials, for combining good properties of different cellulosic raw materials and providing novel and competitive solutions, which can eventually compete with and replace existing synthetic materials. It is essential to recognize that even if the regenerated cellulose films are polymer films, they are converted from solution and not via melting, resulting unique film structure in molecules interaction and crystallinity and not ending to material not melting. The application of regenerated film are partially same as the thermoplastic polymer films but exceeding them for example in stiffness and ability to be used in elevated temperatures.

### EXAMPLES

### Proof-of-Concept-Regenerated Cellulose Samples:

Commercial dissolving grade softwood pulp was purchased from Domsjö Fabriker A B. The pulp was repulped in deionised water overnight and divided into three separate batches. Two of these were ozone treated to reduce their average molecular weights. All pulps were then freeze-dried and grinded with a 1 mm sieve (Fritsch Pulverisette Variable-Speed Rotor Mill) to ensure an even distribution of dissolution solvent in later steps. Intrinsic viscosities of pulps were measured by using a standard procedure ISO 5351_2010 and Mark-Houwink's equation (IUPAC 1997) was used to determine the viscometric average degree of polymerizations (DPᵥ) of the pulps. Molecular weights and polydispersities were determined according to Berthold et al. (2001). Pulps and their characteristics are shown in FIG. 2. Commercial 4-Methylmorpholine N-oxide monohydrate (NMMO, >95% N-content) and propyl gallate (propyl-3,4,5-trihydroxibenzoat) were purchased from Sigma-Aldrich, Finland.

Celluloses were dissolved with a 6-slotted Radleys Carousel Cooker (Tech 825W) by using NMMO-H₂O as a solvent. NMMO-H₂O was added into a 250 mL glass flask and propyl gallate (PG) was added by 0.1 wt. % (per absolute dry cellulose) as a stabilizer. The NMMO-H₂O-PG mixture was heated to 80° C. until it melted. Celluloses with three different molecular weights (65, 168 and 375 kDa) were added into mixture in varying ratios (presented in Table 1). Total dry matter content of all mixtures was kept at 7 wt. %. Samples were left to mix for 24 h at 80° C. under a constant shearing of 30 rpm. Solubility of celluloses in all samples was ensured with a polarizing light microscope imaging (microscope: Nikon Eclipse Ci, LV-UEPI-N, Japan; lens: Nikon Plan 10x/0.25 OFN22 Ph1 DL MRL20102).

TABLE 1
Examined cellulose solutions and their cellulose compositions.

| Cellulose in sample | | | Total | |
|---|---|---|---|---|
| LOW | MEDIUM | HIGH | solids % | Solvent |
| 1 | 0 | 0 | 7% | 85% NMMO/15% H₂O |
| 0 | 1 | 0 | 7% | 85% NMMO/15% H₂O |
| 0 | 0 | 1 | 7% | 85% NMMO/15% H₂O |
| 0.67 | 0.33 | 0 | 7% | 85% NMMO/15% H₂O |
| 0.67 | 0 | 0.33 | 7% | 85% NMMO/15% H₂O |
| 0.33 | 0.67 | 0 | 7% | 85% NMMO/15% H₂O |
| 0 | 0.67 | 0.33 | 7% | 85% NMMO/15% H₂O |
| 0.33 | 0 | 0.67 | 7% | 85% NMMO/15% H₂O |
| 0 | 0.33 | 0 | 7% | 85% NMMO/15% H₂O |
| 0.33 | 0.33 | 0.33 | 7% | 85% NMMO/15% H₂O |
| 0.67 | 0.17 | 0.17 | 7% | 85% NMMO/15% H₂O |
| 0.17 | 0.67 | 0.17 | 7% | 85% NMMO/15% H₂O |
| 0.17 | 0.17 | 0.67 | 7% | 85% NMMO/15% H₂O |

Shear flow viscosities of solutions were measured at 80° C. Linear ramp-in interval from 0.1 to 1000 s⁻¹ with 6 s measurement duration per point (collecting data at 50 different points) was applied to evaluate the effect of increasing shear stress on solution viscosity in short timescales. Results are presented in FIGS. 3-5.

Films were prepared by casting dissolved cellulose solution on a glass surface at 80-90° C. with an Erichsen K Coater film applicator (wet thickness of 400 μm and casting speed of 18 mm s⁻¹). Casted films were precipitated in water bath (tab water, 15° C.) and dried between blotting papers at RT. Films were cut into 15 mm wide strips with a lab film cutter and conditioned at 23° C. and 50% RH at least overnight. Tensile strengths, Young's moduli and strains at break of films were measured by using a Lloyd LS5 materials testing machine (AMETEK measurement and calibration technologies, USA) and a 100 N load cell. The initial grip distance was 30 mm and the rate of the grip separation 10 mm min-1. Six replicates of each film were measured. Thickness of each strip was measured with a digital caliber from three different points and the averages were used for calculations. Results are presented in FIGS. 6-8.

### Effect of Hemicellulose on Viscosity and Mechanical Properties

### Raw Materials:

Dissolution in ionic liquid: [mTBNH][OAc]:
   5-methyl-1,5,7-triaza-bicyclo-[4.3.0]non-6-enium acetate
   Liquid at RT, melting point 15° C., pH 6.5
   C₉H₁₇N₃O₂, 119.19 g/mol
Pulps:
   Dissoving grade sulphite pulp (DSP)
   Bleached kraft pulp (BK) from Metsä Fibre
   Cold alkali extracted (BK-CCE)
   Cold alkali extracted, molar-mass controlled (BK-CCE-P)
   Molar-mass controlled (BK-P)

a) Molecular weight distributions of untreated pulps from SEC analysis. SEC was determined with a derivatizing method because GGM of softwood pulp poorly dissolves in DMAc. Results are presented in FIG. 9.

b) Molecular properties and sugar compositions of untreated pulps obtained by HPLC analysis and calculated to correspond to polymeric xylan (XYL), galactoglucomannan (GGM) and cellulose (CELL) according to Janson et al. (1970). Results are presented in Table 2.

TABLE 2

| | Intrinsic | | | | | | |
|---|---|---|---|---|---|---|---|
| | viscosity | Mw | Mn | | XYL | GGM | CELL |
| Sample | (mL g⁻¹) | (kDa) | (kDa) | PI | (wt-%) | (wt-%) | (wt-%) |
| DSP | 430 ± 3 | 330 ± 8.5 | 36 ± 2 | 9 ± 0.3 | 2.6 ± 0.2 | 3.4 ± 0.2 | 92.4 ± 0.3 |
| BK | 830 ± 15 | 750 ± 57.2 | 92 ± 11.3 | 8.3 ± 1.6 | 12 ± 0.2 | 9.3 ± 0.1 | 77.2 ± 0.2 |
| BK-CCE | 830 ± 0 | 600 ± 59.3 | 88 ± 4.9 | 6.9 ± 0.3 | 4.4 ± 0.1 | 8.3 ± 0.1 | 85.7 ± 0.1 |
| BK-CCE-P | 450 ± 1 | 380 ± 51.7 | 79 ± 0.1 | 4.9 ± 0.7 | 4.1 ± 0.2 | 8 ± 0.3 | 86.2 ± 0.5 |
| BK-P | 430 ± 4 | 320 ± 53.9 | 49 ± 8.2 | 6.6 ± 0 | 10.7 ± 0.1 | 8.3 ± 0.2 | 79.4 ± 0.3 |

Evolution of solution viscosity of pulp (0.25 wt-& abs. dry) in [mTNBH][OAc] in the presence of water, as a function of time, is presented in FIG. 10.

### Mechanical Properties:

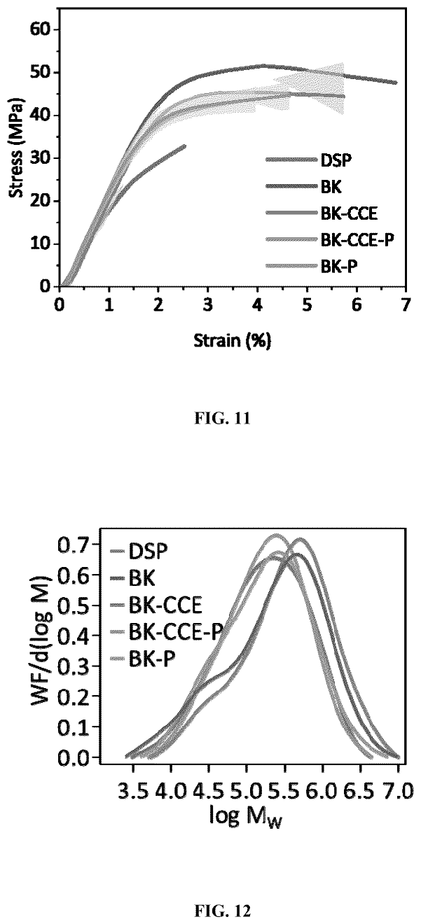

a) Stress-strain curves with standard deviations (n>5) for RC films (up to 5.6 N, the extension rate was 21 mm min-1, actual measurement with an extension rate of 10 mm min-1), as presented in FIG. 11.

b) RC film thicknesses, ultimate tensile strengths, strains at break, Young's moduli and densities, as presented in Table 3.

TABLE 3

| | | Ultimate | | | |
|---|---|---|---|---|---|
| | | tensile | Strain at | Young's | |
| | Thickness | strength | break | modulus | Density |
| RC film | (μm) | (MPa) | (%) | (MPa) | (kg m⁻³) |
| DSP | 40 ± 1.5 | 27 ± 2.3 | 2 ± 0.4 | 2085 ± 184 | 1135 |
| BK | 31 ± 1.2 | 53 ± 3 | 5 ± 1 | 2649 ± 99 | 1002 |
| BK-CCE | 33 ± 2.1 | 46 ± 2.6 | 4 ± 1.1 | 2453 ± 211 | 1083 |
| BK-CCE-P | 36 ± 2.5 | 42 ± 1 | 3 ± 0.5 | 2376 ± 44 | 1068 |
| BK-P | 37 ± 1.5 | 43 ± 2.7 | 4 ± 0.5 | 2419 ± 139 | 1043 |

### Regenerated Cellulose:

a) Molecular weight distributions of untreated pulps from SEC analysis. SEC was determined with a derivatizing method because GGM of softwood pulp poorly dissolves in DMAc. Results presented in FIG. 12.

b) Molecular properties and sugar compositions of untreated pulps obtained by HPLC analysis and calculated to correspond to polymeric xylan (XYL), galactoglucomannan (GGM) and cellulose (CELL) according to Janson et al. (1970). Results presented in Table 4.

TABLE 4

| | Mw | Mn | | XYL | GGM | CELL |
|---|---|---|---|---|---|---|
| Sample | (kDa) | (kDa) | PI | (wt-%) | (wt-%) | (wt-%) |
| DSP | 340 ± 20.7 | 68 ± 2.3 | 5 ± 0.1 | 0.7 ± 0.1 | 1.3 ± 0.1 | 96.4 ± 0.1 |
| BK | 420 ± 31.8 | 50 ± 11.2 | 8.7 ± 2.6 | 8.2 ± 0.4 | 8.2 ± 0.2 | 82 ± 0.5 |
| BK-CCE | 570 ± 39.6 | 113 ± 11.1 | 5.1 ± 0.8 | 2.3 ± 0.1 | 6.3 ± 0.1 | 89.8 ± 0.1 |
| BK-CCE-P | 340 ± 4.6 | 77 ± 8.2 | 4.5 ± 0.5 | 2 ± 0.1 | 6.1 ± 0.2 | 90.4 ± 0.2 |
| BK-P | 240 ± 1.9 | 50 ± 4.9 | 4.8 ± 0.5 | 7.5 ± 0.1 | 7.3 ± 0.2 | 83.6 ± 0.3 |

### CITATION LIST

### Patent Literature

1. WO 2018/228744 A1
2. WO 2019/073370 A1
3. US 2018/0371211 A1
4. US 2019/0316293 A1

### Non-Patent Literature

1. Berthold, F., Gustafsson, K., Sjöholm, E., Lindström, M., An improved method for the determination of softwood kraft pulp molecular mass distributions, In 11th International symposium on Wood and Pulping Chemistry, Nice, France, June 11-14, Vol. 1, 363-366, 2001.
2. IUPAC., (1997). Compendium of chemical terminology. In: A. D. McNaught & A. Wilkinson, (eds). The “Gold Book”. (2nd edn). Oxford: Blackwell Scientific Publications. DOI: 10.1351/goldbook.M03706.
3. Yandi F., Yanhu X., Wei N., Xiangling J., Shuqin B., Characterization of the Microstructure of Bimodal HDPE Resin, Polymer Journal vol. 41, pp. 622-628, 2009.

1. A method for producing bimodal or multimodal cellulose films and/or filaments, the method comprising:
mixing together cellulose raw materials having at least two different average degrees of polymerization, or at least two different average molecular weights or molecular weight distributions,
dissolving the mixed cellulose raw materials in a solvent, thereby forming a solution, and
regenerating the solution into a film or filaments.

2. The method according to claim 1, wherein the average molecular weight of the cellulose raw materials mixed together is between 50 and 900 kDa.

3. The method according to claim 1, wherein the molecular weight ratio of the different cellulose raw materials is below 6.

4. The method according to claim 1, wherein the solution viscosity ratio of the solution is below 20, at 10 s-1 shearing.

5. The method according to claim 1, wherein the solvent is selected from the group consisting of non-derivatizing cellulose solvents, amine oxide cellulose solvents, and alkaline cellulose solvents.

6. The method according to claim 5, wherein the solvent comprises 4-methylmorpholine n-oxide monohydrate.

7. A bimodal or multimodal cellulose film or filament-produced by the process according to claim 1, the film or filament having a tensile strength of at least 30 MPa and an elongation of at least 5%.

8. (canceled)

9. The method according to claim 1, wherein the average molecular weight of the cellulose raw materials mixed together is from 50 to 400 kDa.

10. The method according to claim 1, wherein the molecular weight ratio of the different cellulose raw materials is from 2.5 to 6.

11. The method according to claim 1, wherein the solution viscosity ratio of the solution is from 5 to 20, at 10 s-1 shearing.

12. The method according to claim 1, wherein the solvent is a mixture of 4-methylmorpholine n-oxide monohydrate and water.
